(19) United States
(12) Patent Application Publication
(10) Pub. No.: US 2025/0346289 A1
(43) Pub. Date: Nov. 13, 2025

(54) VEHICLE STEERING APPARATUS

(71) Applicant: HL MANDO CORPORATION, Gyeonggi-do (KR)

(72) Inventor: Jaejin JUNG, Gyeonggi-do (KR)

(21) Appl. No.: 19/203,066

(22) Filed: May 8, 2025

(30) Foreign Application Priority Data
May 8, 2024 (KR) 10-2024-0060243

(51) Int. Cl. B62D 5/04; B62D 3/12

(52) U.S. Cl. CPC B62D 5/0442; B62D 3/12; B62D 5/0424

(57) ABSTRACT

A vehicle steering apparatus may include a rack housing on which a motor shaft and a ball nut are mounted, a motor pulley coupled to the motor shaft, a nut pulley coupled to the ball nut, a drive belt coupled to the motor pulley and the nut pulley, and a belt support member coupled to the rack housing and supported to narrow a gap between one outer peripheral surface and the other outer peripheral surface of the drive belt.

### CROSS-REFERENCE TO RELATED APPLICATIONS

This application claims the priority of Korean Patent Application No. 10-2024-0060243 filed on May 8, 2024, in the Korean Intellectual Property Office, the disclosure of which is incorporated herein by reference.

### BACKGROUND

### Field

The present embodiments relate to a vehicle steering apparatus.

### Description of the Related Art

In general, a vehicle steering apparatus has been developed and applied with power steering to assist a steering wheel operation force of a driver and provide convenience in driving operation, and the power steering has been developed and applied in the form of hydraulic type that uses hydraulic pressure, electro-hydraulic type that uses hydraulic pressure and electric power of a motor simultaneously, and electric type that uses only electric power of a motor.

However, as the durability of the vehicle steering apparatus decreases and tension of a belt decreases, a belt, motor pulley, and nut pulley do not mesh stably with each other and a meshing area decreases, so that there is a problem that accurate steering power is not transmitted, and noise and vibration occur, and the belt is damaged.

In addition, in cases where a tooth jump phenomenon occurs in an emergency situation in a state where the steering is performed urgently during the driving of the vehicle, there is also a problem that the safety of driving the vehicle is affected.

Therefore, there is an increasing need for a vehicle steering apparatus that can maintain belt tension even after the durability decreases, transmit precise steering force, reduce noise and vibration, and prevent tooth jump phenomenon to ensure vehicle driving safety.

### SUMMARY

Accordingly, the present embodiments have been devised in consideration of the background described above, and an object thereof is to provide a vehicle steering apparatus capable of maintaining belt tension even after durability of the vehicle steering apparatus decreases, transmitting accurate steering force, reducing noise and vibration, and preventing tooth jump phenomenon, thereby ensuring vehicle driving safety.

Furthermore, the purposes of the present embodiments are not limited thereto, and other purposes not mentioned will be clearly understood by those skilled in the art from the description below.

According to the present embodiments, there may be provided a vehicle steering apparatus including: a rack housing in which at least a part of a motor shaft and at least a part of a ball nut are disposed; a motor pulley provided on the motor shaft; a nut pulley provided on the ball nut; a drive belt connecting between the motor pulley and the nut pulley; and a belt support member coupled to the rack housing and supporting one outer surface portion and another outer surface portion of the drive belt to press the one outer surface portion and the another outer surface portion of the drive belt in a direction toward each other.

According to these exemplary embodiments, it is possible to maintain belt tension even after durability of the vehicle steering apparatus decreases, transmit accurate steering force, reduce noise and vibration, and prevent tooth jump phenomenon, thereby ensuring vehicle driving safety.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF THE DRAWINGS

The above and other aspects, features and other advantages of the present disclosure will be more clearly understood from the following detailed description taken in conjunction with the accompanying drawings, in which:

FIG. 1 is a perspective view illustrating a part of a vehicle steering apparatus according to the present embodiments;

FIGS. 2 and 3 are front views illustrating a part of the vehicle steering apparatus according to the present embodiments;

FIG. 4 is a perspective view illustrating a part of the vehicle steering apparatus according to the present embodiments;

FIG. 5 is an exploded perspective view illustrating a part of the vehicle steering apparatus according to the present embodiments;

FIGS. 6 and 7 are front views illustrating a part of the vehicle steering apparatus according to the present embodiments;

FIG. 8 is a perspective view illustrating a part of the vehicle steering apparatus according to the present embodiments; and

FIG. 9 is a front view illustrating a part of the vehicle steering apparatus according to the present embodiments.

### DETAILED DESCRIPTION OF THE EMBODIMENT

In the following description of examples or embodiments of the present disclosure, reference will be made to the accompanying drawings in which it is illustrated by way of illustration specific examples or embodiments that can be implemented, and in which the same reference numerals and signs can be used to designate the same or like components even when they are illustrated in different accompanying drawings from one another. Further, in the following description of examples or embodiments of the present disclosure, detailed descriptions of well-known functions and components incorporated herein will be omitted when it is determined that the description may make the subject matter in some embodiments of the present disclosure rather unclear. The terms such as “including”, “having”, “containing”, “constituting” “make up of”, and “formed of”' used herein are generally intended to allow other components to be added unless the terms are used with the term “only”. As used herein, singular forms are intended to include plural forms unless the context clearly indicates otherwise.

Terms, such as “first”, “second”, “A”, “B”, “(A)”, or “(B)” may be used herein to describe elements of the disclosure. Each of these terms is not used to define essence, order, sequence, or number of elements or the like, but is used merely to distinguish the corresponding element from other elements.

When it is mentioned that a first element “is connected or coupled to”, “contacts or overlaps” or the like a second element, it should be interpreted that, not only can the first element “be directly connected or coupled to” or “directly contact or overlap” the second element, but a third element can also be “interposed” between the first and second elements, or the first and second elements can “be connected or coupled to”, “contact or overlap”, or the like each other via a fourth element. Here, the second element may be included in at least one of two or more elements that “are connected or coupled to”, “contact or overlap”, or the like each other.

When time relative terms, such as “after,” “subsequent to,” “next,” “before,” and the like, are used to describe processes or operations of elements or configurations, or flows or steps in operating, processing, manufacturing methods, these terms may be used to describe non-consecutive or non-sequential processes or operations unless the term “directly” or “immediately” is used together.

In addition, when any dimensions, relative sizes or the like are mentioned, it should be considered that numerical values for an elements or features, or corresponding information (for example, level, range, or the like) include a tolerance or error range that may be caused by various factors (for example, process factors, internal or external impact, noise, or the like) even when a relevant description is not specified. Further, the term “may” fully encompass all the meanings of the term “can”.

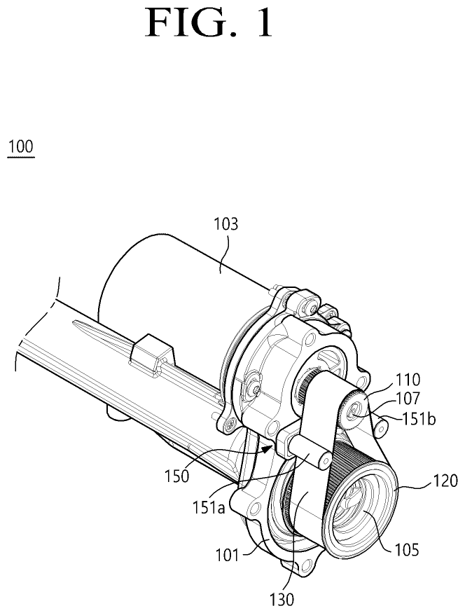

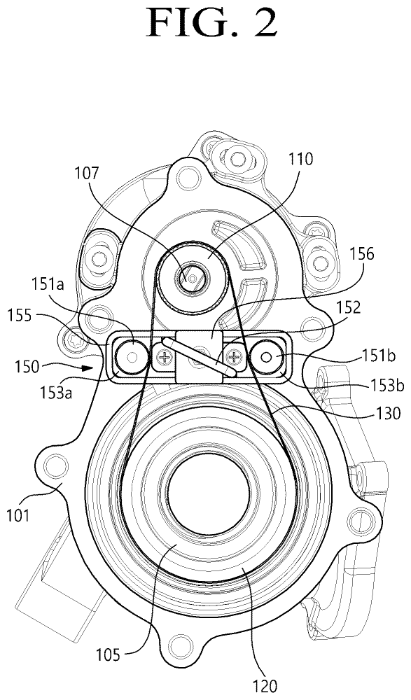

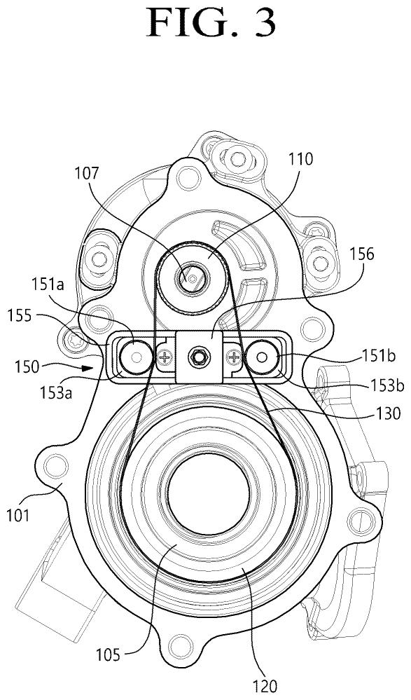

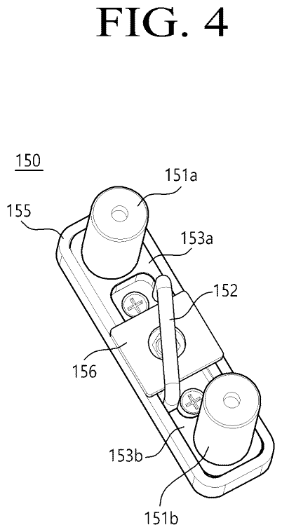

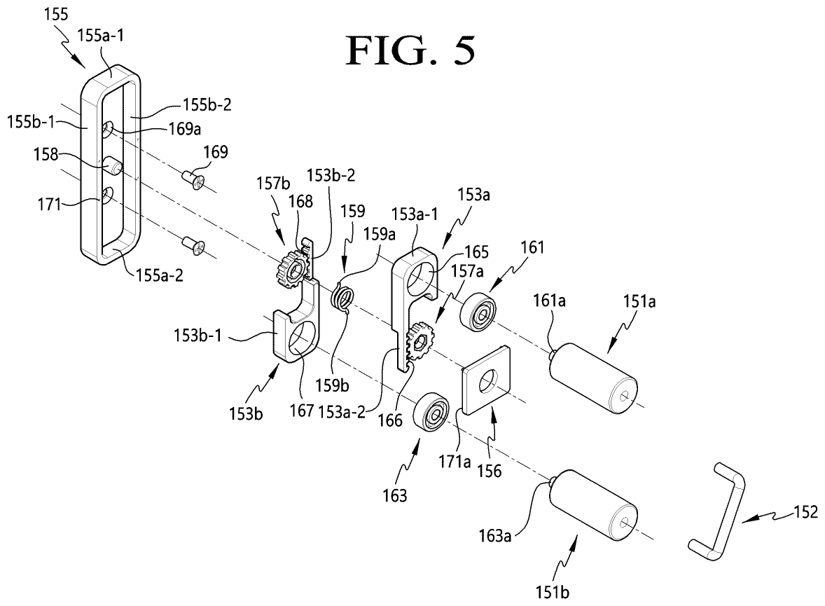

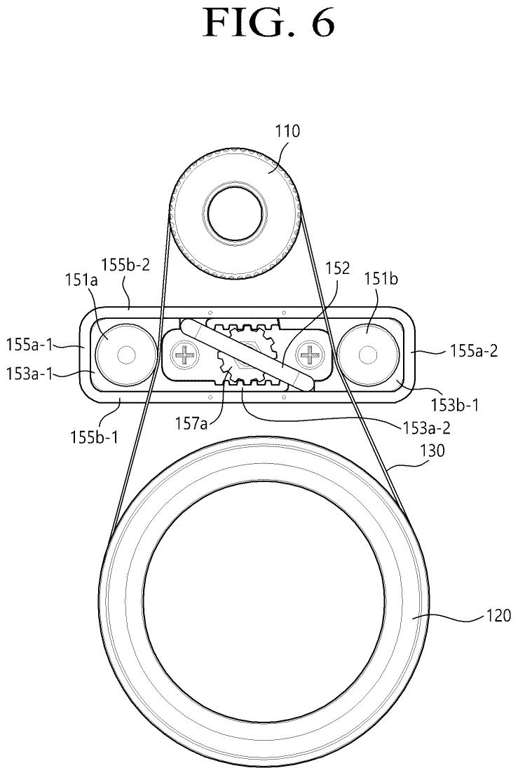

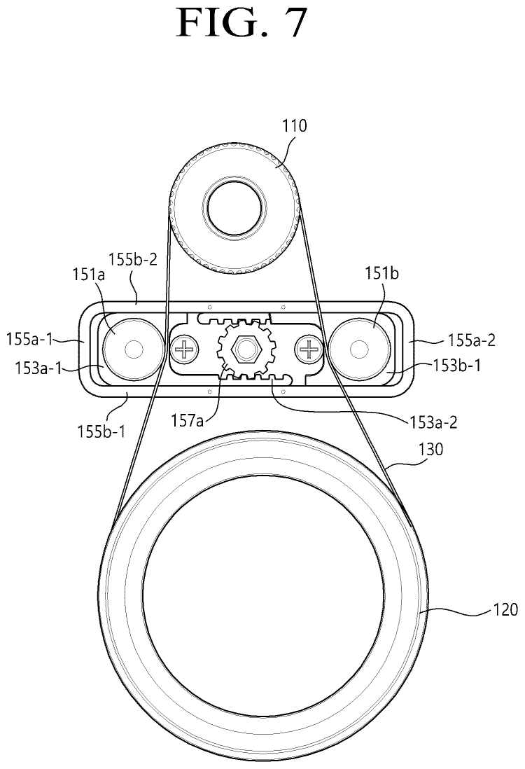

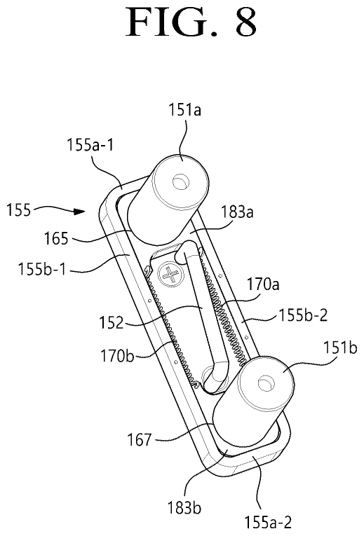

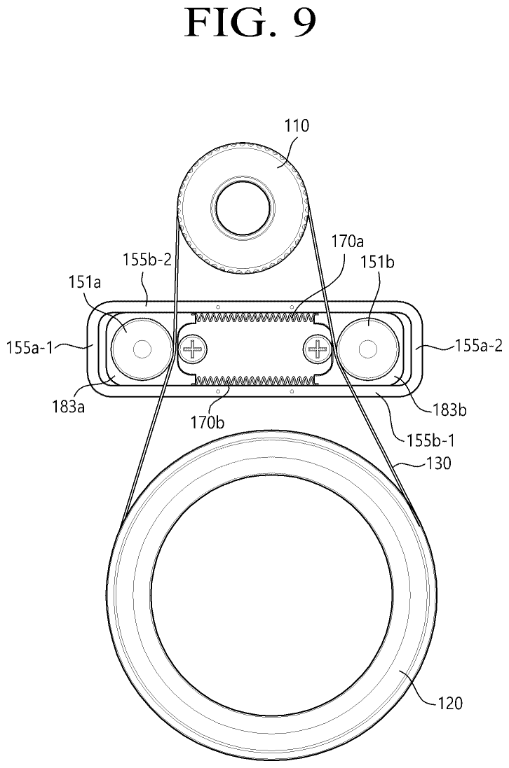

FIG. 1 is a perspective view illustrating a part of a vehicle steering apparatus according to the present embodiments, FIGS. 2 and 3 are front views illustrating a part of the vehicle steering apparatus according to the present embodiments, FIG. 4 is a perspective view illustrating a part of the vehicle steering apparatus according to the present embodiments, FIG. 5 is an exploded perspective view illustrating a part of the vehicle steering apparatus according to the present embodiments, FIGS. 6 and 7 are front views illustrating a part of the vehicle steering apparatus according to the present embodiments, FIG. 8 is a perspective view illustrating a part of the vehicle steering apparatus according to the present embodiments, and FIG. 9 is a front view illustrating a part of the vehicle steering apparatus according to the present embodiments.

As illustrated in these drawings, the vehicle steering apparatus according to the present embodiments includes a rack housing 101 in which at least a part of a motor shaft 107 and at least a part of a ball nut 105 are disposed, a motor pulley 110 provided on the motor shaft 107, a nut pulley 120 provided on the ball nut 105, a drive belt 130 connecting between the motor pulley 110 and the nut pulley 120, and a belt support member 150 coupled to the rack housing 101 and supporting one outer surface portion and another outer surface portion of the drive belt to press the one outer surface portion and the another surface portion of the drive belt 130 in a direction toward each other.

The vehicle steering apparatus according to these embodiments includes a driving means and a driven means for assisting steering force, and the driving means includes a motor 103 controlled by an electronic control device, the motor pulley 110 coupled to the motor shaft 107 and transmitting the driving force of the motor 103 to the nut pulley 120 via the drive belt 130, the drive belt 130, or the like.

The drive belt 130 is connected to the motor pulley 110 and the nut pulley 120 and transmits the rotational power of the motor pulley 110 to the nut pulley 120.

In addition, the driven means includes the ball nut 105 coupled with a rack bar (not illustrated) inside the rack housing 101 in which the rack bar is built, the nut pulley 120 coupled to the outer peripheral surface of the ball nut 105, or the like.

The motor pulley 110 coupled to the motor shaft 107 and the nut pulley 120 coupled to the ball nut 105 are disposed with their central axes parallel to each other, and the drive belt 130 is coupled to the motor pulley 110 and the nut pulley 120 to transmit the rotational power of the motor to the rack bar through the ball nut 105, and the rack bar is moved left and right by the operation of the ball nut 105 to generate steering assistance force.

The ball nut 105 is coupled with the rack bar via a ball and rotates to slide the rack bar inside the rack housing 101 and gear housing (not illustrated). The nut pulley 120 that rotates the ball nut 105 is mounted on the outer peripheral surface of the ball nut 105, so that the rack bar can be moved left and right to generate the steering assistance force.

In this way, the nut pulley 120 that rotates the ball nut 105 rotates in conjunction with the motor pulley 110 via the drive belt 130. However, after the durability decreases, the tension of the drive belt 130 decreases, causing slip to occur between the motor pulley 110, the nut pulley 120, and the drive belt 130, resulting in a decrease in power transmission performance.

In a case of assembling the rack housing 101 and the motor, the tension of the drive belt 130 is measured and the rack housing 101 and the motor 103 are assembled at a position corresponding to the set tension value. However, after the durability decreases, the tension decreases or the drive belt 130 slips due to rapid operation of the steering wheel or impact input from the road surface.

In particular, there is a concern that a tooth jump phenomenon may occur in which teeth formed on the motor pulley 110, nut pulley 120, and drive belt 130 jump, resulting in improper steering.

Accordingly, in the present embodiments, the belt support member 150 that adjusts the tension of the drive belt 130 is supported by one outer peripheral surface and the other outer peripheral surface of the drive belt 130 to apply pressure to the drive belt 130 to narrow the gap of the drive belt 130 and is connected to the rack housing 101.

The belt support member 150 includes a first roller 151a supporting the one portion of the outer surface portion of the drive belt 130, a second roller 151b supporting the another outer surface portion of the drive belt 130, a first position gear 153a to which the first roller 151a is rotatably coupled, a second position gear 153b to which the second roller 151b is rotatably coupled, a first torsion gear 157a engaged with the first position gear 153a, a second torsion gear 157b engaged with the second position gear 153b, a torsion spring 159 disposed between the first torsion gear 157a and the second torsion gear 157b, and a support housing 155 in which the first roller 151a, the second roller 151b, the first position gear 153a, the second position gear 153b, the first torsion gear 157a, the second torsion gear 157b, and the torsion spring 159 are included, the support housing 155 fixed to the rack housing 101.

The first roller 151a and the second roller 151b have the same shape and are rotatably coupled to the first position gear 153a and the second position gear 153b, and are supported by one outer peripheral surface and the other outer peripheral surface of the drive belt 130.

The first position gear 153a to which the first roller 151a is coupled is coupled to the first torsion gear 157a, and the second position gear 153b to which the second roller 151b is coupled is coupled to the second torsion gear 157b.

Moreover, in a case where the first torsion gear 157a and the second torsion gear 157b rotate in opposite directions by the action of the torsion spring 159, the first position gear 153a and the second position gear 153b slide in opposite directions along the inner surface of the support housing 155.

The support housing 155 has a roughly rectangular tray shape. Moreover, the first position gear 153a, the second position gear 153b, the first torsion gear 157a, the second torsion gear 157b, the torsion spring 159, and the like are built in the support housing 155, and the support housing 155 is coupled and fixed to the rack housing 101 and a fastening member 169 through a fastening hole 169a provided on the bottom surface.

Here, the first position gear 153a may include a first guide portion 153a-1 having a first support hole 165 to which the first roller 151a is coupled and supported by an inner side surface at one end portion of the support housing 155, and a first toothed portion 153a-2 extending from one side of the first guide portion 153a-1, and comprising one side supported by one side 155b-1 of an inner side surface located between the one end portion and another end portion of the support housing 155, and another side having a first gear tooth 166 engaged with the first torsion gear 157a.

The first support hole 165 to which the first roller 151a is coupled is disposed on one side of the first guide portion 153a-1, and the first toothed portion 153a-2 is disposed on the other side of the first guide portion 153a-1. In a case where the first torsion gear 157a rotates, the first position gear 153a is supported by one side 155b-1 of the side end portion of the support housing 155 by the first gear tooth 166 tooth-engaging with the first torsion gear 157a, and slides.

In addition, a first rotation support 161 is coupled between the first roller 151a and the first support hole 165 to support the rotation of the first roller 151a, and a first protruding end portion 161a inserted into the first rotation support 161 is provided at an end portion of the first roller 151a.

The second position gear 153b may include a second guide portion 153b-1 that has a second support hole 167 to which the second roller 151b is coupled and is supported by the inner surface at the another end portion of the support housing 155, and a second toothed portion 153b-2 that extends from the second guide portion 153b-1, and comprises one side supported by another inner side surface located between the one end portion and another end portion of the support housing 155, and another side has a second gear tooth 168 engage with the second torsion gear 157b.

The second support hole 167 to which the second roller 151b is coupled is disposed on one side of the second guide portion 153b-1, and the second toothed portion 153b-2 is disposed on the other side of the second guide portion 153b-1. In a case where the second torsion gear 157b rotates, the second position gear 153b is supported by the other side 155b-2 of the side end portion of the support housing 155 by the second gear tooth 168 tooth-engaging with the second torsion gear 157b, and slides.

In addition, a second rotation support 163 is coupled between the second roller 151b and the second support hole 167 to support the rotation of the second roller 151b, and a second protruding end portion 163a inserted into the second rotation support 163 is provided at the end portion of the second roller 151b.

The first toothed portion 153a-2 is formed to be spaced apart from the inner bottom surface of the support housing 155, and the second toothed portion 153b-2 is formed to be in contact with the inner bottom surface of the support housing 155, so that the first toothed portion 153a-2 and the second toothed portion 153b-2 are disposed so as not to be positioned on the same plane.

The inner bottom surface of the support housing 155 is provided with a torsion gear support portion 158 which protrudes upward and to which the first torsion gear 157a and the second torsion gear 157b are rotatably coupled.

The first torsion gear 157a and the second torsion gear 157b are coupled to the torsion gear support portion 158, and the first torsion gear 157a is stacked on and coupled to the upper side of the second torsion gear 157b, so that the first torsion gear 157a is coupled to the first toothed portion 153a-2, and the second torsion gear 157b is coupled to the second toothed portion 153b-2.

Here, the torsion spring 159 is disposed between the first torsion gear 157a and the second torsion gear 157b, and one end of the torsion spring 159 is supported by the second torsion gear 157b and the other end of the torsion spring 159 is supported by the first torsion gear 157a.

Accordingly, the first torsion gear 157a and the second torsion gear 157b rotate in opposite directions due to the action of the torsion spring 159, and accordingly, the first position gear 153a and the second position gear 153b also slide in opposite directions along one side 155b-1 and the other side 155b-2 of the side end portion of the support housing 155.

In addition, a housing cover 156 that prevents the first torsion gear 157a and the second torsion gear 157b from being separated may be coupled to the upper end of the support housing 155. In the present embodiments, for example, a configuration is illustrated, in which a fixing groove 171 is formed at the upper end of the support housing 155 and a fixing protrusion 171a is formed at the lower end of the housing cover 156 so that the fixing groove 171 and the fixing protrusion 171a are engaged and coupled with each other.

In addition, the belt support member 150 may further include a fixing member 152 that supports the inner surface of the first guide portion 153a-1 at one end portion and the inner surface of the second guide portion 153b-1 at the other end portion and fixes the operation position of the torsion spring 159.

As illustrated in FIG. 2, the fixing member 152 fixes the first position gear 153a and the second position gear 153b so that they do not move in a case of assembling the belt support member 150 to the rack housing 101.

Then, in a case where the fixing member 152 is removed after the belt support member 150 is assembled to the rack housing 101 and the drive belt 130 is mounted to the first roller 151a and the second roller 151b, as illustrated in FIG. 3, the first position gear 153a and the second position gear 153b slide in a direction that brings them closer to each other by the action of the torsion spring 159, and thus, the first roller 151a and the second roller 151b pressurize the drive belt 130 to narrow the gap of the drive belt 130.

If this is explained in more detail with reference to FIGS. 6 and 7, as illustrated in FIG. 6, in a state where the fixing member 152 is mounted, the first position gear 153a maintains a state of being in close contact with the inner peripheral surface of one end portion 155a-1 of the support housing 155, and the second position gear 153b maintains a state of being in close contact with the inner peripheral surface of the other end portion 155a-2 of the support housing 155.

In this case, since the first torsion gear 157a is fixed, the first toothed portion 153a-2 is fixed in a state of being supported by the inner peripheral surface of one side 155b-1 of the side end portion of the support housing 155. Moreover, since the second torsion gear 157b is also fixed, the second toothed portion 153b-2 is fixed in a state of being supported by the inner peripheral surface of the other side 155b-2 of the side end portion of the support housing 155.

Moreover, as illustrated in FIG. 7, in a state where the fixing member 152 is removed, the first position gear 153a is pulled while the first torsion gear 157a rotates, so that the first position gear 153a is separated from the inner peripheral surface of one end portion 155a-1 of the support housing 155, and at the same time, the second position gear 153b is pulled while the second torsion gear 157b rotates, so that the second position gear 153b is also separated from the inner peripheral surface of the other end portion 155a-2 of the support housing 155.

Accordingly, the distance between the first roller 151a and the second roller 151b decreases by the combined distance of the separation distance of the first position gear 153a and the separation distance of the second position gear 153b, and thus, the drive belt 130 is pressurized to narrow the gap of the drive belt 130.

Meanwhile, the belt support member 150 illustrated in FIGS. 8 and 9 may include the first roller 151a supported by one outer peripheral surface of the drive belt 130, the second roller 151b supported by the other outer peripheral surface of the drive belt 130, a first movable member 183a to which the first roller 151a is rotatably coupled, a second movable member 183b to which the second roller 151b is rotatably coupled, tension springs 170a and 170b coupled to the first moving member 183a and the second moving member 183b, and the support housing 155 in which the first roller 151a, the second roller 151b, the first moving member 183a, the second moving member 183b, and the tension springs 170a and 170b are built in and which is fixed to the rack housing 101.

Here, except for the first moving member 183a, the second moving member 183b, and the tension spring 170a and 170b, the first roller 151a, the second roller 151b, and the support housing 155 are the same as those in FIGS. 1 to 5, so a detailed description thereof will be omitted.

As illustrated in FIG. 8, the first moving member 183a has the first support hole 165 to which the first roller 151a is coupled and is supported by the inner peripheral surface of one end portion of the support housing 155, and the second moving member 183b has the second support hole 167 to which the second roller 151b is coupled and is supported by the inner peripheral surface of the other end portion of the support housing 155.

Moreover, the first rotation support 161 illustrated in FIG. 5 is coupled between the first roller 151a and the first support hole 165 to support the rotation of the first roller 151a, and the first protruding end portion 161a inserted into the first rotation support 161 is provided at the end portion of the first roller 151a.

The second rotation support 163 as illustrated in FIG. 5 is also coupled between the second roller 151b and the second support hole 167 to support the rotation of the second roller 151b, and the second protruding end portion 163a inserted into the second rotation support 163 is provided at the end portion of the second roller 151b.

The tension springs 170a and 170b are disposed in a direction in which the first moving member 183a and the second moving member 183b face each other, and a pair of tension springs 170a and 170b may be provided in the first moving member 183a and the second moving member 183b at positions close to one side and the other side of the side end portion of the support housing 155 so that the supporting force is uniform.

In addition, the belt support member 150 may further include the fixing member 152 that supports the inner surface of the first moving member 183a at one end portion and the inner surface of the second moving member 183b at the other end portion and fixes the operation position of the tension springs 170a and 170b.

The fixing member 152 fixes the first moving member 183a and the second moving member 183b so that they do not move, as illustrated in FIG. 8.

If this is explained in more detail with reference to FIGS. 8 and 9, as illustrated in FIG. 8, in a state where the fixing member 152 is mounted, the first moving member 183a maintains a state of being in close contact with the inner peripheral surface of one end portion 155a-1 of the support housing 155, and the second moving member 183b maintains a state of being in close contact with the inner peripheral surface of the other end portion 155a-2 of the support housing 155.

In this case, the tension springs 170a and 170b are maintained in a state where both ends are tensioned toward one end portion and the other end portion of the support housing 155.

Moreover, as illustrated in FIG. 9, in a state where the fixing member 152 is removed, the first moving member 183a and the second moving member 183b are pulled while the tension springs 170a and 170b returns, so that the first moving member 183a is separated from the inner peripheral surface of one end portion 155a-1 of the support housing 155, and the second moving member 183b is also separated from the inner peripheral surface of the other end portion 155a-2 of the support housing 155.

Accordingly, the distance between the first roller 151a and the second roller 151b decreases by the combined distance of the separation distance of the first moving member 183a and the separation distance of the second moving member 183b, and thus, the drive belt 130 is pressurized to narrow the gap of the drive belt 130.

According to these embodiments, it is possible to maintain belt tension even after durability of the vehicle steering apparatus decreases, transmit accurate steering force, reduce noise and vibration, and prevent tooth jump phenomenon, thereby ensuring vehicle driving safety.

The above description has been presented to enable any person skilled in the art to make and use the technical idea of the present disclosure, and has been provided in the context of a particular application and its requirements. Various modifications, additions and substitutions to the described embodiments will be readily apparent to those skilled in the art, and the general principles defined herein may be applied to other embodiments and applications without departing from the spirit and scope of the present disclosure. The above description and the accompanying drawings provide an example of the technical idea of the present disclosure for illustrative purposes only. That is, the disclosed embodiments are intended to illustrate the scope of the technical idea of the present disclosure. Thus, the scope of the present disclosure is not limited to the embodiments illustrated, but is to be accorded with the widest scope consistent with the claims.

What is claimed is:

1. A vehicle steering apparatus comprising:
a rack housing in which at least a part of a motor shaft and at least a part of a ball nut are disposed;
a motor pulley provided on the motor shaft;
a nut pulley provided on the ball nut;
a drive belt connecting between the motor pulley and the nut pulley; and
a belt support member coupled to the rack housing and supporting one outer surface portion and another outer surface portion of the drive belt to press the one outer surface portion and the another outer surface portion of the drive belt in a direction toward each other.

2. The vehicle steering apparatus of claim 1, wherein the belt support member includes
a first roller supporting the one outer surface portion of the drive belt,
a second roller supporting the another outer surface portion of the drive belt,
a first position gear to which the first roller is rotatably coupled,
a second position gear to which the second roller is rotatably coupled,
a first torsion gear engaged with the first position gear,
a second torsion gear engaged with the second position gear,
a torsion spring disposed between the first torsion gear and the second torsion gear, and
a support housing in which the first roller, the second roller, the first position gear, the second position gear, the first torsion gear, the second torsion gear, and the torsion spring are included, the support housing fixed to the rack housing.

3. The vehicle steering apparatus of claim 2, wherein the first position gear includes:
a first guide portion having a first support hole to which the first roller is coupled and supported by an inner side surface at one end portion of the support housing, and
a first toothed portion extending from the first guide portion, and comprising one side supported by a second portion of an inner side surface located between the one end portion and another end portion of the support housing and another side having a first gear tooth engaged with the first torsion gear.

4. The vehicle steering apparatus of claim 3, further comprising a first rotation support coupled between the first roller and the first support hole to support rotation of the first roller.

5. The vehicle steering apparatus of claim 4, wherein the first roller comprises a first protruding end portion inserted into the first rotation support.

6. The vehicle steering apparatus of claim 3, wherein the second position gear includes:
a second guide portion having a second support hole to which the second roller is coupled and supported by an inner surface at the another end portion of the support housing, and
a second toothed portion extending from the second guide portion, and comprising one side supported by another inner side surface located between the one end portion and another end portion of the support housing and another side having a second gear tooth engaged with the second torsion gear.

7. The vehicle steering apparatus of claim 6, further comprising a second rotation support coupled between the second roller and the second support hole to support rotation of the second roller.

8. The vehicle steering apparatus of claim 7, wherein the second roller comprises a second protruding end portion inserted into the second rotation support.

9. The vehicle steering apparatus of claim 6, wherein the first toothed portion of the first position gear is spaced apart from an inner bottom surface of the support housing and the second toothed portion is in contact with the inner bottom surface of the support housing.

10. The vehicle steering apparatus of claim 9, wherein the first torsion gear and the second torsion gear are rotatably coupled to a torsion gear support protruding from the inner bottom surface of the support housing.

11. The vehicle steering apparatus of claim 10, wherein the first torsion gear is positioned between the inner bottom surface of the support housing and the second torsion gear.

12. The vehicle steering apparatus of claim 11, wherein the torsion spring is disposed between the first torsion gear and the second torsion gear, and one end of the torsion spring is supported by the second torsion gear and another end of the torsion spring is supported by the first torsion gear.

13. The vehicle steering apparatus of claim 11, further comprising a housing cover covering the first torsion gear and the second torsion gear and coupled to a top end of the support housing.

14. The vehicle steering apparatus of claim 11, wherein the belt support member further includes a fixing member having one end portion supporting the first guide portion and another end portion supporting the second guide portion, the fixing member fixing a position of the torsion spring.

15. The vehicle steering apparatus of claim 1, wherein the belt support member includes:
a first roller supporting the one portion of the outer surface of the drive belt,
a second roller supporting the another portion of the outer surface of the drive belt,
a first movable member to which the first roller is rotatably coupled,
a second movable member to which the second roller is rotatably coupled,
a tension spring coupled between the first movable member and the second movable member, and
a support housing in which the first roller, the second roller, the first movable member, the second movable member, and the tension spring are included, the support housing fixed to the rack housing.

16. The vehicle steering apparatus of claim 15, wherein the first movable member includes a first support hole to which the first roller is coupled and is supported by an inner side surface at one end portion of the support housing.

17. The vehicle steering apparatus of claim 16, wherein a first rotation support is coupled between the first roller and the first support hole of the first movable member to support rotation of the first roller, and the first roller has a first protruding end portion inserted into the first rotation support.

18. The vehicle steering apparatus of claim 16, wherein the second movable member includes a second support hole to which the second roller is coupled and is supported by an inner side surface at another end portion of the support housing.

19. The vehicle steering apparatus of claim 18, wherein a second rotation support member is coupled between the second roller and the second support hole of the second movable member to support rotation of the second roller, and the second roller has a second protruding end portion inserted into the second rotation support.

20. The vehicle steering apparatus of claim 16, wherein the belt support member further includes a fixing member having one end portion supporting the first movable member and another end portion supporting the second movable member, the fixing member fixing a position of the tension spring.
